(19) United States
(12) Patent Application Publication
(10) Pub. No.: US 2026/0291221 A1
(43) Pub. Date: Sep. 24, 2026

(54) ON-CHIP SURGE PROTECTION CIRCUIT

(71) Applicant: Airoha Technology Corp, Hsinchu City (TW)

(72) Inventors: Cheng-Hsu Wu, Hsinchu County (TW); Tsung-Hsien Hsieh, Taipei City (TW); Yuan-Fu Lyu, Hsinchu County (TW); Ching-Hsuan Lin, New Taipei City (TW); Hsuan-An Wei, Taoyuan City (TW)

(73) Assignee: Airoha Technology Corp, Hsinchu City (TW)

(21) Appl. No.: 19/088,945

(22) Filed: Mar. 24, 2025

(51) Int. Cl. H02H 9/04; H02H 1/00

(52) U.S. Cl. CPC H02H 9/046; H02H 1/0007

(57) ABSTRACT

An on-chip surge protection circuit includes a first voltage rail, a second voltage rail, a third voltage rail, a coupling circuit, and a protection circuit. The first voltage rail provides a first voltage to at least one protected device. The second voltage rail provides a second voltage to the at least one protected device, where the second voltage is lower than the first voltage. The coupling circuit is coupled between the first voltage rail and the third voltage rail. The protection circuit is coupled between the third voltage rail and the second voltage rail. The on-chip surge protection circuit and the at least one protected device are integrated in a same chip.

### BACKGROUND OF THE INVENTION

### 1. Field of the invention

The present invention relates to a surge protection technique, and more particularly, to an on-chip surge protection circuit that employs a first feature of using an additional voltage rail and a coupling circuit to reduce or eliminate surge-induced disturbance on a supply voltage and/or a second feature of sharing the same protection circuit between surge protection and ESD protection.

### 2. Description of the Prior Art

A surge event refers to an instant overcurrent or overvoltage occurring in an electronic circuit, and it may cause the damage of the electronic circuit. One typical surge protection solution is using an on-board surge protector which is located on a printed circuit board (PCB) and external to a chip that requires surge protection. Since the on-board surge protector is outside the chip, it needs additional components and occupies additional areas on the PCB. Thus, there is a need for an innovative on-chip surge protection circuit which is implemented inside the chip that requires surge protection.

### SUMMARY OF THE INVENTION

One of the objectives of the claimed invention is to provide an on-chip surge protection circuit that employs a first feature of using an additional voltage rail and a coupling circuit to reduce or eliminate surge-induced disturbance on a supply voltage and/or a second feature of sharing the same protection circuit between surge protection and ESD protection.

According to a first aspect of the present invention, an exemplary on-chip surge protection circuit is disclosed. The exemplary on-chip surge protection circuit includes a first voltage rail, a second voltage rail, a third voltage rail, a coupling circuit, and a protection circuit. The first voltage rail is arranged to provide a first voltage to at least one protected device. The second voltage rail is arranged to provide a second voltage to the at least one protected device, wherein the second voltage is lower than the first voltage. The coupling circuit is coupled between the first voltage rail and the third voltage rail. The protection circuit is coupled between the third voltage rail and the second voltage rail. The on-chip surge protection circuit and the at least one protected device are integrated in a same chip.

According to a second aspect of the present invention, an exemplary on-chip surge protection circuit is disclosed. The exemplary on-chip surge protection circuit includes a surge detection circuit, an electrostatic discharge (ESD) detection circuit, and a protection circuit. The surge detection circuit is arranged to detect occurrence of a surge event on a first voltage rail, and generate a first control signal. The ESD detection circuit is arranged to detect occurrence of an ESD event on the first voltage rail, and generate a second control signal. The protection circuit is coupled between the first voltage rail and a second voltage rail, and jointly controlled by the first control signal and the second control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a first on-chip surge protection circuit according to an embodiment of the present invention.

FIG. 2 is a diagram illustrating a front-end integrated circuit with an on-chip surge protection circuit integrated therein according to an embodiment of the present invention.

FIG. 3 is a diagram illustrating an operation principle of the proposed on-chip surge protection circuit shown in FIG. 1.

FIG. 4 is a diagram illustrating a surge current path according to an embodiment of the present invention.

FIG. 5 is a diagram illustrating a second on-chip surge protection circuit according to an embodiment of the present invention.

FIG. 6 is a diagram illustrating a third on-chip surge protection circuit according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

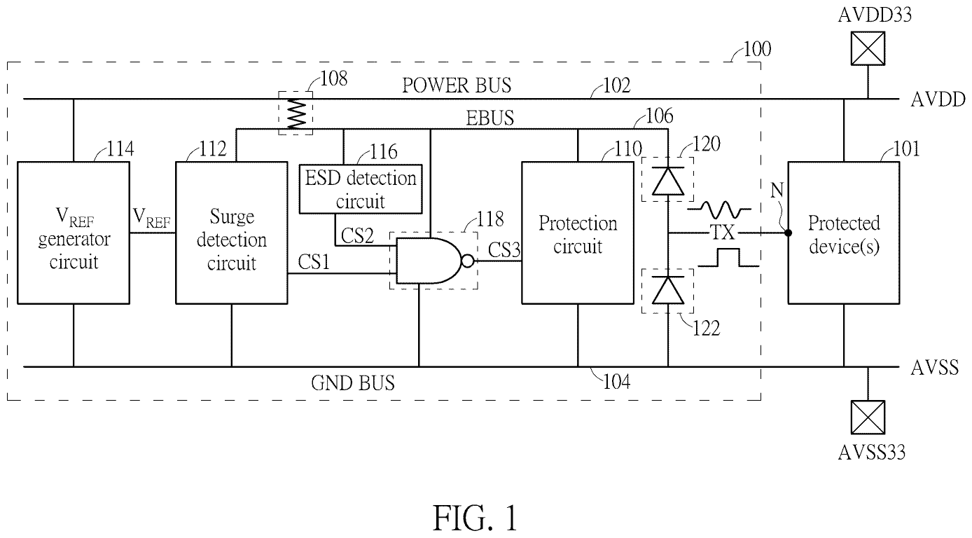

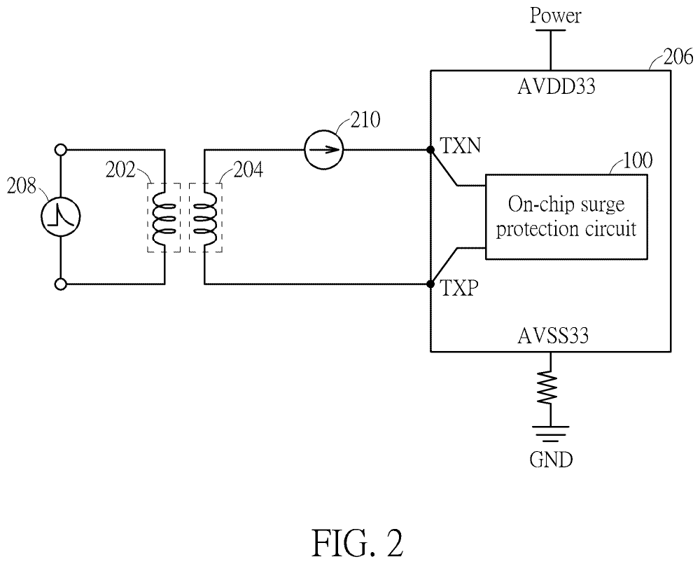

FIG. 1 is a diagram illustrating a first on-chip surge protection circuit according to an embodiment of the present invention. The on-chip surge protection circuit 100 and at least one protected device 101 are integrated in a same chip. For example, the on-chip surge protection circuit 100 and the at least one protected device 101 may be integrated in a front-end integrated circuit (FEIC). FIG. 2 is a diagram illustrating a front-end integrated circuit with an on-chip surge protection circuit integrated therein according to an embodiment of the present invention. As shown in FIG. 2, an electronic device may include a primary-side transformer 202, a secondary-side transformer 204, and an FEIC 206, where the FEIC 206 employs the proposed on-chip surge protection circuit 100 shown in FIG. 1. A differential transmitter output (TX) of the FEIC 206 includes a positive signal output from a positive transmitter differential output pin TXP and a negative signal output from a negative transmitter differential output pin TXN. In addition, a supply voltage of the FEIC 206 is received from a power pin AVDD33, and a ground voltage of the FEIC 206 is received from a ground pin AVSS33. In FIG. 2, a surge 208 is coupled from the primary-side transformer 202 to the secondary-side transformer 204, and induces an overcurrent 210 in the secondary-side transformer 204, which flows through the transmitter output of the FEIC 206.

The present invention aims at realizing the on-chip surge protection circuit 100 inside the FEIC 206. As shown in FIG. 1, the on-chip surge protection circuit 100 may include a voltage rail (labeled by “POWER BUS”) 102, a voltage rail (labeled by “GND BUS”) 104, a voltage rail (labeled by “EBUS”) 106, a coupling circuit 108, a protection circuit 110, a surge detection circuit 112, a reference voltage generator circuit (labeled by “V_{REF} generator circuit”) 114, an electrostatic discharge (ESD) detection circuit 116, a logic circuit 118, a pull-up circuit 120, and a pull-down circuit 122.

The voltage rail 102 is a high voltage rail that is connected to the power pin AVDD33. Hence, a first voltage (i.e., a supply voltage) AVDD is provided via the voltage rail 102 after the FEIC 206 is powered on. The voltage rail 104 is a low voltage rail that is connected to the ground pin AVSS33. Hence, a second voltage (i.e., a ground voltage) AVSS is provided via the voltage rail 104 after the FEIC 206 is powered on, where AVSS is lower than AVDD. In this embodiment, each protected device 101 is coupled between the voltage rail 102 and the voltage rail 104. Hence, the first voltage (i.e., supply voltage) AVDD is provided to each protected device 101 via the voltage rail 102, and the second voltage (i.e., ground voltage) AVSS is provided to each protected device 101 via the voltage rail 104.

The proposed on-chip surge protection circuit 100 further uses an additional voltage rail (i.e., voltage rail 106) that is separated from the voltage rail 102. Compared to a protection circuit that is coupled between the voltage rail 102 and the voltage rail 104 for providing a bypass path between the voltage rail 102 and the voltage rail 104, the protection circuit 110 of the proposed on-chip surge protection circuit 100 is coupled between the voltage rail 106 and the voltage rail 104 for providing a bypass path between the voltage rail 106 and the voltage rail 104, where the voltage rail 106 is not responsible for delivering the supply voltage AVDD used by the protected device(s) 101. In addition, compared to a surge detection circuit that is coupled between the voltage rail 102 and the voltage rail 104 for detecting occurrence of a surge event on the voltage rail 102 that delivers the supply voltage AVDD used by the protected device(s) 101, the surge detection circuit 112 of the proposed on-chip surge protection circuit 100 is coupled between the voltage rail 106 and the voltage rail 104 for detecting occurrence of a surge event on the voltage rail 106 that is not responsible for delivering the supply voltage AVDD used by the protected device(s) 101. For example, the surge detection circuit 112 may be implemented using a voltage detection circuit that receives a reference voltage V_{REF} generated from the reference voltage generator circuit 114 coupled between the voltage rail 102 and the voltage rail 104, where the reference voltage V_{REF} is generated based on the first voltage (i.e., supply voltage) AVDD and the second voltage (i.e., ground voltage) AVSS. In this embodiment, the surge detection circuit 112 is arranged to detect occurrence of a surge event on the voltage rail 106, and generate a control signal CS1, where the protection circuit (e.g., a clamp transistor) 110 is controlled according to at least the control signal CS1. That is, a trigger signal of the protection circuit (e.g., clamp transistor) 110 is based at least partly on the control signal CS1.

As shown in FIG. 1, the pull-up circuit 120 is coupled between the voltage rail 106 and a transmitter output node N (e.g., N=TXP) of the protected device(s) 101, and the pull-down circuit 122 is coupled between the transmitter output node N (e.g., N=TXP) of the protected device(s) 101 and the voltage rail 104. For example, each of the pull-up circuit 120 and the pull-down circuit 122 may be implemented using a diode.

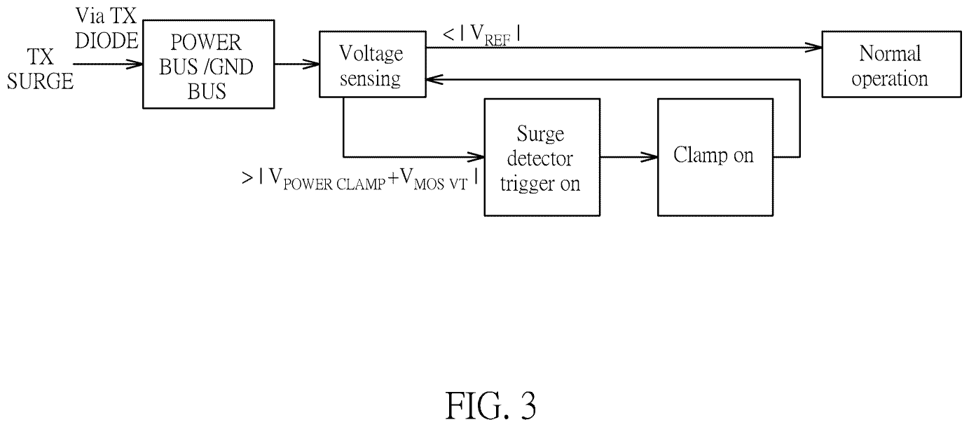

Please refer to FIG. 1 in conjunction with FIG. 3. FIG. 3 is a diagram illustrating an operation principle of the proposed on-chip surge protection circuit 100 shown in FIG. 1. When a surge event occurs on the differential transmitter output (TX) of the FEIC 206, the surge event (particularly, a positive surge voltage induced by the surge event) may be passed to the voltage rail 106 through the pull-up circuit (e.g., forward-biased diode) 120. Hence, when the voltage on the voltage rail 106 has an abrupt increase due to the surge event, the surge detection circuit 112 detects occurrence of the surge event on the voltage rail 106 through voltage sensing, and generates the control signal CS1 (e.g., CS1=0) indicative of occurrence of the surge event. Since the protection circuit 110 is controlled by the control signal CS1, the protection circuit (e.g., clamp transistor) 110 is enabled/trigged due to the control signal CS1 (e.g., CS1=0), to activate a bypass path for guiding most of the abnormal current caused by the surge event from the voltage rail 106 to the voltage rail 104.

When there is no surge event occurring on the transmitter output of the FEIC 206, the voltage on the voltage rail 106 is maintained at a predetermined voltage level. In addition, the surge detection circuit 112 does not detect occurrence of the surge event on the voltage rail 106 through voltage sensing, and generates the control signal CS1 (e.g., CS1=1) indicative of absence of the surge event. Since the protection circuit 110 is controlled by the control signal CS1, the protection circuit (e.g., clamp transistor) 110 is not enabled/triggered due to the control signal CS1 (e.g., CS1=1), such that there is no bypass path activated between the voltage rail 106 and the voltage rail 104. Hence, each protected device 101 performs its normal operation under a condition that surge protection is not in operation. In other words, the proposed on-chip surge protection circuit 100 has no impact on the normal operation of each protected circuit 101 integrated in the same chip (e.g., FEIC 206).

In this embodiment, the coupling circuit 108 is coupled between the voltage rail 102 and the voltage rail 106 to prevent the voltage rail 106 from being floating. For example, the coupling circuit 108 may be implemented using a resistor. Hence, during a period in which there is no surge event occurring on the voltage rail 106, the coupling circuit 108 ensures a fixed voltage relationship between a voltage on the voltage rail 106 and the supply voltage AVDD on the voltage rail 102. After a surge event occurs on the voltage rail 106, the voltage sensing function of the surge detection circuit 112 can operate correctly for detecting occurrence of the surge event. In addition, the coupling circuit (e.g., resistor) 108 can limit the current flowing between the voltage rail 106 and the voltage rail 102, thereby preventing the voltage of the voltage rail 102 from being disturbed (e.g., decreased to a voltage level much lower than a nominal supply voltage value) during a period in which a surge event occurs.

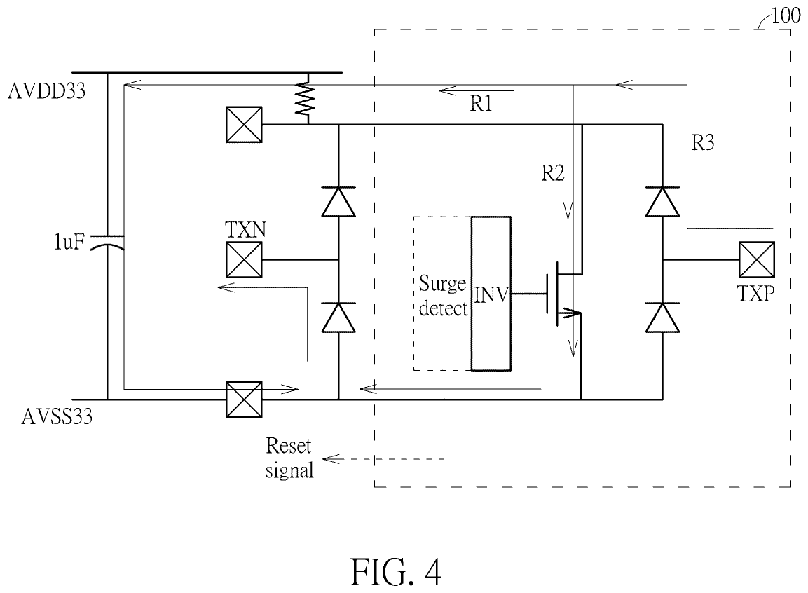

FIG. 4 is a diagram illustrating a surge current path according to an embodiment of the present invention. Suppose that the pull-up circuit (e.g., diode) 120 is coupled between the voltage rail 106 and the transmitter differential output pin TXP, and the pull-down circuit (e.g., diode) 122 is coupled between the transmitter differential output pin TXP and the voltage rail 104. When a surge event occurs on the differential transmitter output (TX) of the FEIC 206, a negative surge voltage may be induced on the transmitter differential output pin TXN, and a positive surge voltage may be induced on the transmitter differential output pin TXP. The surge event (particularly, the positive surge voltage induced by the surge event) is passed to the voltage rail 106 via the pull-up circuit (e.g., diode) 120, as indicated by the current path R3 (TXP→DIODE→EBUS). The surge detection circuit 112 detects occurrence of the surge event on the voltage rail 106 to set the control signal CS1 (e.g., CS1=0). In addition, the protection circuit (e.g., clamp transistor) 110 is enabled/trigged by a trigger signal which may be set by an inverted version of the control signal CS1 (e.g., CS1=0), to activate a bypass path between the voltage rails 106 and 104, as indicated by the current path R2 (EBUS→CLAMP→GND BUS→DIODE→TXN). Since the additional voltage rail 106 is separated from the voltage rail 102 that provides the supply voltage AVDD to circuit components within the protected device(s) 101 and most of the abnormal current caused by the surge event is bypassed from the voltage rail 106 to the voltage rail 104, surge-induced disturbance on the supply voltage AVDD of the voltage rail 102 can be reduced or eliminated. In addition, a remainder of the abnormal current caused by the surge event may be guided to the voltage rail 104 through the current path R1 (EBUS→GND BUS→DIODE→TXN). Since the coupling circuit (e.g., resistor) 108 can limit the current flowing between the voltage rail 106 and the voltage rail 102, surge-induced disturbance on the supply voltage AVDD of the voltage rail 102 may also be protected by the coupling circuit (e.g., resistor) 108. It should be noted that the coupling circuit 108 may be implemented using a circuit component other than the resistor. That is, actual implementation of the coupling circuit 108 may depend on design considerations.

In this embodiment, the same protection circuit (e.g., clamp transistor) 110 is shared by surge protection and ESD protection. As shown in FIG. 1, the ESD detection circuit 116 is arranged to detect occurrence of an ESD event on the voltage rail 106, and generate a control signal CS2. For example, when there is an ESD event on the voltage rail 106, the ESD detection circuit 116 generates the control signal CS2 (e.g., CS2=0) indicative of occurrence of the ESD event; and when there is no ESD event on the voltage rail 106, the ESD detection circuit 116 generates the control signal CS2 (e.g., CS2=1) indicative of absence of the ESD event. The protection circuit 110 is jointly controlled by the control signals CS1 and CS2. For example, a trigger signal of the protection circuit 110 is based on both of the control signals CS1 and CS2. As shown in FIG. 1, the logic circuit 118 is arranged to receive the control signals CS1 and CS2, and perform a logic operation upon the control signals CS1 and CS2 to generate and output a control signal CS3 to the protection circuit 110. The control signal CS3 acts as a trigger signal of the protection circuit 110. For example, the logic circuit 118 may be implemented using a NAND gate. Hence, a bypass path between the voltage rails 106 and 104 is activated by the protection circuit (e.g., clamp transistor) 110 during a period in which any of the surge event and the ESD event is detected. It should be noted that an ESD event is different from a surge event. For example, an ESD event occurs before the FEIC 206 is powered on (i.e., the power pin AVDD33 is not provided with the supply voltage AVDD from a voltage source, and the ground pin AVSS33 is not provided with the ground voltage AVSS from the voltage source), and a surge event occurs after the FEIC 206 is powered on (i.e., the power pin AVDD33 is provided with the supply voltage AVDD from a voltage source, and the ground pin AVSS33 is provided with the ground voltage AVSS from the voltage source).

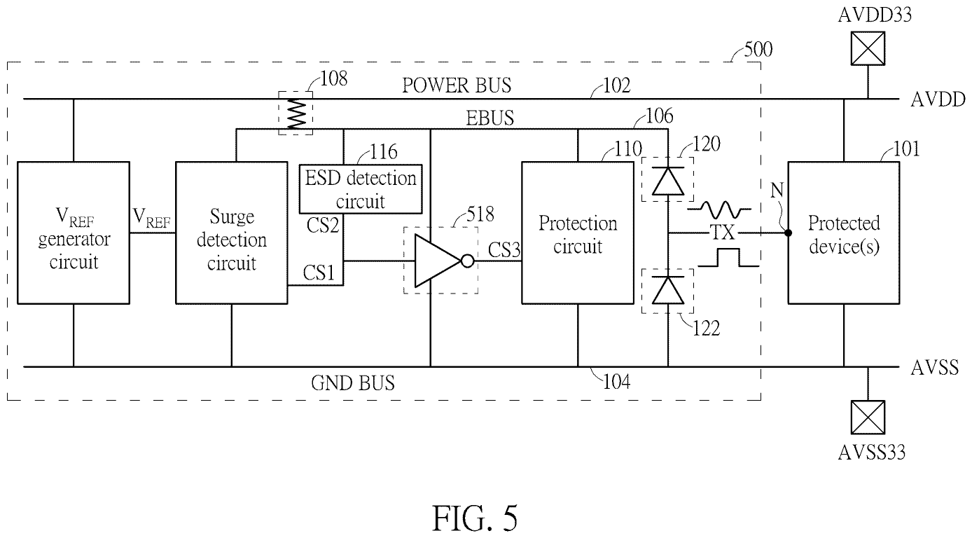

In the embodiment shown in FIG. 1, the logic circuit 118 may be implemented using a NAND gate. However, this is for illustrative purposes only, and is not meant to be a limitation of the present invention. FIG. 5 is a diagram illustrating a second on-chip surge protection circuit according to an embodiment of the present invention. The major difference between on-chip surge protection circuits 100 and 500 is that the logic circuit 518 may be implemented using an inverter.

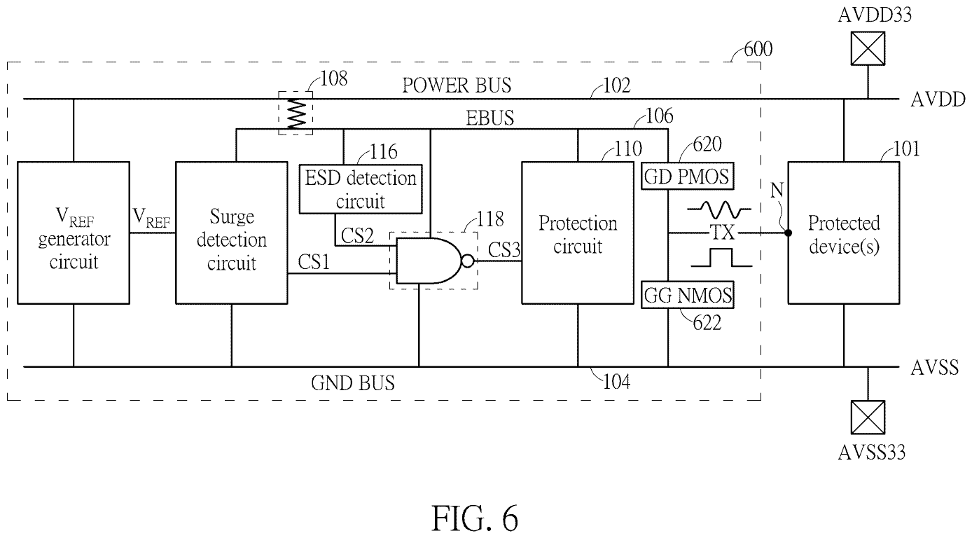

In the embodiment shown in FIG. 1, each of the pull-up circuit 120 and the pull-down circuit 122 may be implemented using a diode. However, this is for illustrative purposes only, and is not meant to be a limitation of the present invention. FIG. 6 is a diagram illustrating a third on-chip surge protection circuit according to an embodiment of the present invention. The major difference between on-chip surge protection circuits 100 and 600 is that the pull-up circuit (labeled by “GD PMOS”) 620 may be implemented using a gate-to-drain P-channel metal-oxide-semiconductor (GD PMOS) transistor 620, and the pull-down circuit (labeled by “GG NMOS”) 622 may be implemented using a gate-grounded N-channel metal-oxide-semiconductor (GG NMOS) transistor.

Regarding the embodiments shown in FIG. 1, FIG. 5, and FIG. 6, each of the proposed on-chip surge protection circuits 100, 500, and 600 employs a first feature of using the additional voltage rail 106 and the coupling circuit 108 to reduce or eliminate surge-induced disturbance on the supply voltage of the voltage rail 102 and a second feature of sharing the same protection circuit (e.g., clamp transistor) between surge protection and ESD protection. However, these are for illustrative purposes only, and are not meant to be limitations of the present invention. In some embodiments of the present invention, the proposed on-chip surge protection circuit 100/500/600 may be modified to omit one of the first feature and the second feature. In practice, any on-chip surge protection circuit using one or both of the first feature and the second feature falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An on-chip surge protection circuit, comprising:
a first voltage rail, arranged to provide a first voltage to at least one protected device;
a second voltage rail, arranged to provide a second voltage to the at least one protected device, wherein the second voltage is lower than the first voltage;
a third voltage rail;
a coupling circuit, coupled between the first voltage rail and the third voltage rail; and
a protection circuit, coupled between the third voltage rail and the second voltage rail;
wherein the on-chip surge protection circuit and the at least one protected device are integrated in a same chip.

2. The on-chip surge protection circuit of claim 1, wherein the coupling circuit is a resistor.

3. The on-chip surge protection circuit of claim 1, further comprising:
a surge detection circuit, coupled between the third voltage rail and the second voltage rail, wherein the surge detection circuit is arranged to detect occurrence of a surge event on the third voltage rail, and generate a first control signal, wherein the protection circuit is controlled according to at least the first control signal.

4. The on-chip surge protection circuit of claim 3, further comprising:
a reference voltage generator circuit, coupled between the first voltage rail and the second voltage rail, wherein the reference voltage generator circuit is arranged to generate and output a reference voltage to the surge detection circuit.

5. The on-chip surge protection circuit of claim 3, further comprising:
an electrostatic discharge (ESD) detection circuit, arranged to detect occurrence of an ESD event on the third voltage rail, and generate a second control signal, wherein the protection circuit is jointly controlled by the first control signal and the second control signal.

6. The on-chip surge protection circuit of claim 5, further comprising:
a logic circuit, arranged to receive the first control signal and the second control signal, and perform a logic operation upon the first control signal and the second control signal to generate and output a third control signal to the protection circuit.

7. The on-chip surge protection circuit of claim 6, wherein the logic circuit is a NAND gate.

8. The on-chip surge protection circuit of claim 6, wherein the logic circuit is an inverter.

9. The on-chip surge protection circuit of claim 1, further comprising:
a pull-up circuit, coupled between the third voltage rail and a transmitter output node of the at least one protected device; and
a pull-down circuit, coupled between the transmitter output node of the at least one protected device and the second voltage rail.

10. The on-chip surge protection circuit of claim 9, wherein each of the pull-up circuit and the pull-down circuit is a diode.

11. The on-chip surge protection circuit of claim 9, wherein the pull-up circuit is a gate-to-drain P-channel metal-oxide-semiconductor (GD PMOS) transistor, and the pull-down circuit is a gate-grounded N-channel metal-oxide-semiconductor (GG NMOS) transistor.

12. An on-chip surge protection circuit, comprising:
a surge detection circuit, arranged to detect occurrence of a surge event on a first voltage rail, and generate a first control signal;
an electrostatic discharge (ESD) detection circuit, arranged to detect occurrence of an ESD event on the first voltage rail, and generate a second control signal; and
a protection circuit, coupled between the first voltage rail and a second voltage rail, wherein the protection circuit is jointly controlled by the first control signal and the second control signal.

13. The on-chip surge protection circuit of claim 12, further comprising:
a logic circuit, arranged to receive the first control signal and the second control signal, and perform a logic operation upon the first control signal and the second control signal to generate and output a third control signal to the protection circuit.

14. The on-chip surge protection circuit of claim 13, wherein the logic circuit is a NAND gate.

15. The on-chip surge protection circuit of claim 13, wherein the logic circuit is an inverter.

16. The on-chip surge protection circuit of claim 12, further comprising:
a pull-up circuit, coupled between the first voltage rail and a transmitter output node of at least one protected device; and
a pull-down circuit, coupled between the transmitter output node of the at least one protected device and the second voltage rail;
wherein the on-chip surge protection circuit and the at least one protected device are integrated in a same chip.

17. The on-chip surge protection circuit of claim 16, wherein each of the pull-up circuit and the pull-down circuit is a diode.

18. The on-chip surge protection circuit of claim 16, wherein the pull-up circuit is a gate-to-drain P-channel metal-oxide-semiconductor (GD PMOS) transistor, and the pull-down circuit is a gate-grounded N-channel metal-oxide-semiconductor (GG NMOS) transistor.
